(19) United States
(12) Patent Application Publication
(10) Pub. No.: US 2015/0268847 A1
(43) Pub. Date: Sep. 24, 2015

(54) DIGITAL MUSIC DEVICE AND METHODS FOR MANAGING DIGITAL MUSIC

(71) Applicant: EMILY TRISTA LANE, St. Louis, MO (US)

(72) Inventor: EMILY TRISTA LANE, St. Louis, MO (US)

(21) Appl. No.: 14/667,321

(22) Filed: Mar. 24, 2015

Related U.S. Application Data
(60) Provisional application No. 61/969,518, filed on Mar. 24, 2014.

(51) Int. Cl. G06F 3/0484; G09B 15/02

(52) U.S. Cl. CPC G06F 3/04847; G06F 3/04842; G09B 15/023

(57) ABSTRACT

A digital music computer device and methods for managing digital music are provided. The device includes a memory and a processor communicatively coupled to the memory. The processor is programmed to display digital music data associated with a digital music composition, receive additional data associated with the digital music data, the additional data input by a user, combine the additional data and the digital music data to generate updated digital music data, and transmit the updated digital music data to at least one second digital music computer device in substantially real-time based on a transmit request input by the user.

### CROSS REFERENCE TO RELATED APPLICATIONS

This application is a non-provisional application and claims priority to U.S. Provisional Patent Application Ser. No. 61/969,518 filed Mar. 24, 2014 for “DIGITAL MUSIC DEVICE”, which is hereby incorporated by reference in its entirety.

### BACKGROUND OF THE DISCLOSURE

This disclosure relates generally to digital music and, more particularly, to a digital music device and methods for managing digital music.

In at least some known orchestral and/or musical band settings, musicians read from printed paper copies of sheet music. Printed sheet music is costly to purchase and is easily lost or destroyed. In some settings, such as a symphony, a librarian is employed to organize and manage the sheet music for all of the members. Moreover, during a rehearsal, two or more musicians may share one set of sheet music and any edits and/or notes are then reproduced or shared after the rehearsal, which can be time consuming and can lead to inconsistency within practice parts. Additionally, musicians read and practice music with autonomy, even when in an ensemble. When playing in an ensemble, the group is led by a conductor, a director, and section leaders and the entire group should play with a unified voice. As decisions are made during rehearsal and practice (such as bowing and phrasing decisions), it is a challenge to share the information throughout the sections in a live environment, which may compromise practice and performance. In addition, in educational settings, after a musician studies with a teacher, the teacher may not always be present during time of practice to reinforce the lessons, which may lead a student to practicing incorrectly.

### BRIEF DESCRIPTION OF THE DISCLOSURE

In one aspect, a digital music computer device for managing digital music is provided. The device includes a memory and a processor communicatively coupled to the memory. The processor is programmed to display digital music data associated with a digital music composition, receive additional data associated with the digital music data, the additional data input by a user, combine the additional data and the digital music data to generate updated digital music data, and transmit the updated digital music data to at least one second digital music computer device in substantially real-time based on a transmit request input by the user.

In another aspect, a computer-implemented method is provided for managing digital music. The method uses a digital music computer device having a processor and a memory and includes displaying, by the digital music computer device, digital music data associated with a digital music composition; receiving, by the digital music computer device, additional data associated with the digital music data, the additional data input by a user; combining, by the digital music computer device, the additional data and the digital music data to generate updated digital music data; and transmitting, by the digital music computer device, the updated digital music data to at least one second digital music computer device in substantially real-time based on a transmit request input by the user.

### BRIEF DESCRIPTION OF THE DRAWINGS

FIG. 1 illustrates an example configuration of a digital music device.

FIG. 2 is a simplified block diagram of an example digital music system including a plurality of digital music devices connected in communication.

FIG. 3 shows an example configuration of a database within the digital music device shown in FIG. 1.

FIG. 4 is a block diagram of an example orchestral setting.

FIG. 5 is a screenshot of an exemplary menu of the digital music device shown in FIG. 1.

### DETAILED DESCRIPTION

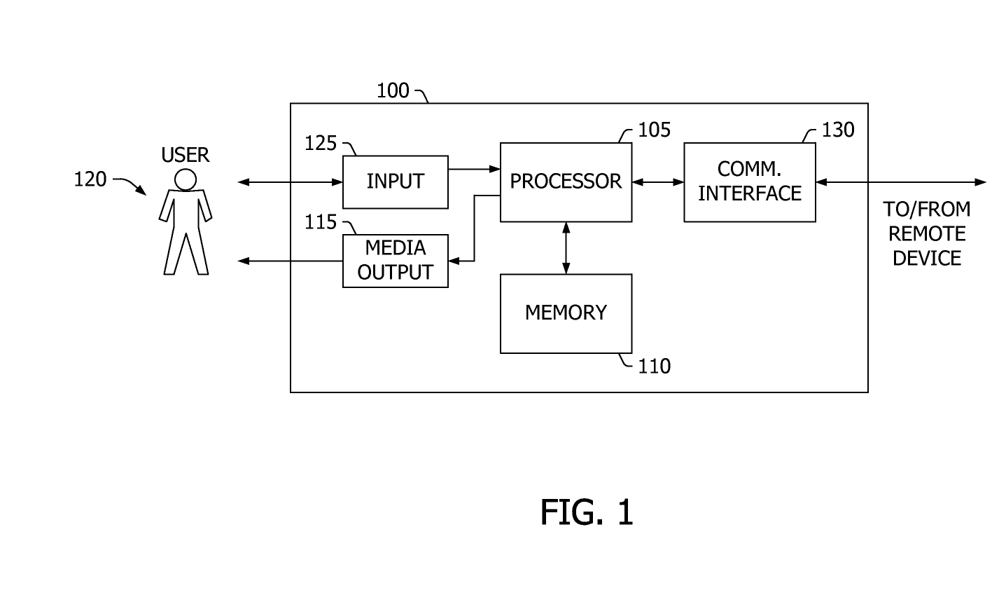

FIG. 1 illustrates an example configuration of a digital music computing device 100 that may be used to read, edit, annotate, and/or organize sheet music. In the exemplary embodiment, digital music device 100 includes a processor 105 for executing instructions. In some embodiments, executable instructions are stored in a memory area 110. Processor 105 may include one or more processing units, for example, a multi-core configuration. Memory area 110 is any device allowing information such as executable instructions and/or written works to be stored and retrieved. Memory area 110 may include one or more computer readable media.

Digital music device 100 also includes at least one media output component 115 for presenting information to user 120. Media output component 115 is any component capable of conveying information to user 120. In some embodiments, media output component 115 includes an output adapter such as a video adapter and/or an audio adapter. In some embodiments, media output component 115 may be a log file that includes output describing actions taken by computer system 100. An output adapter is operatively coupled to processor 105 and operatively couplable to an output device such as a display device, a liquid crystal display (LCD), organic light emitting diode (OLED) display, or “electronic ink” display, or an audio output device, a speaker or headphones. Media output component 115 supports indoor and outdoor visibility and variable lighting.

In some embodiments, digital music device 100 includes an input device 125 for receiving input from user 120. Input device 125 may include, for example, a keyboard, a pointing device, a mouse, a stylus, a touch sensitive panel, a touch pad, a touch screen, a gyroscope, an accelerometer, a position detector, a motion detector, a video input device, and/or an audio input device. A single component such as a touch screen may function as both an output device of media output component 115 and input device 125.

Digital music device 100 may also include a communication interface 130, which is communicatively couplable to other computing devices and/or other digital music devices 100. Communication interface 130 may include, for example, a wired or wireless network adapter or a wireless data transceiver for use with a wireless network, a mobile phone network, Global System for Mobile communications (GSM), 3G, or other mobile data network or Worldwide Interoperability for Microwave Access (WIMAX).

Stored in memory area 110 are, for example, computer readable instructions for providing a user interface to user 120 via media output component 115 and, optionally, receiving and processing input from input device 125. Memory 110 includes, but is not limited to, any computer-operated hardware suitable for storing and/or retrieving computer-executable instructions and/or data. Memory 110 may include random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). Further, memory 110 may include multiple storage units such as hard disks or solid state disks in a redundant array of inexpensive disks (RAID) configuration. Memory 110 may include a storage area network (SAN) and/or a network attached storage (NAS) system. In some implementations, memory area 110 includes memory that is integrated in digital music device 100. For example, digital music device 100 may include one or more hard disk drives as memory 110. Memory 110 may also include memory that is external to digital music device 100 and may be accessed by a plurality of digital music devices 100. The above memory types are exemplary only, and are thus not limiting as to the types of memory usable for storage of processor-executable instructions and/or data.

A user interface may include, among other possibilities, a web browser and client application. Web browsers enable users, such as user 120, to display and interact with media and other information typically embedded on a web page or a website. A client application allows user 120 to interact with a server application.

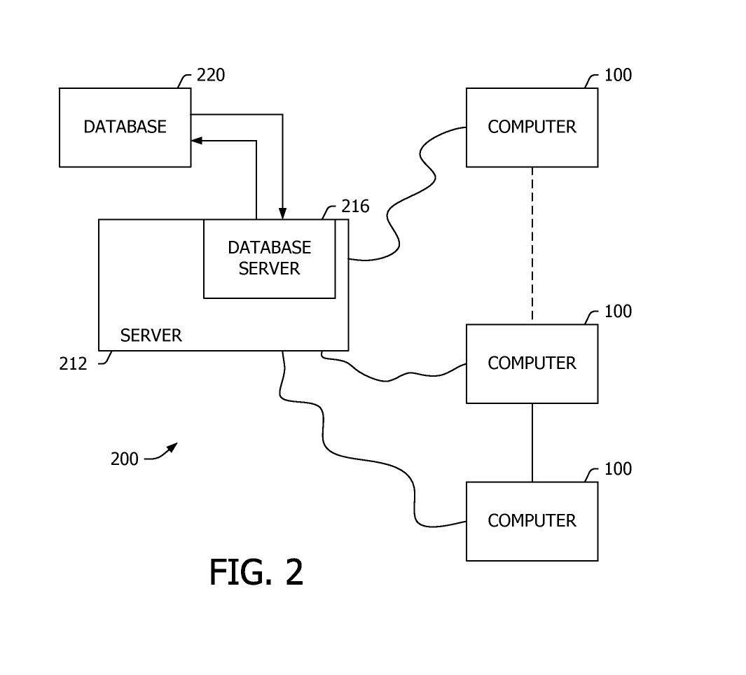

FIG. 2 is a simplified block diagram of an example digital music system 200 including a plurality of digital music devices 100 connected in communication in accordance with the present disclosure. In the exemplary embodiment, system 200 is used for communication of music sheet information between a plurality of digital music devices 100.

More specifically, in the exemplary embodiment, system 200 includes a server system 212, and a plurality of client systems, also referred to as digital music devices 100, connected to server system 212. Digital music devices 100 may be interconnected to the Internet and/or local networks through many interfaces including a network 215, such as a local area network (LAN) or a wide area network (WAN), wireless network, dial-in-connections, cable modems, special high-speed Integrated Services Digital Network (ISDN) lines, and RDT networks. Digital music devices 100 could be any device capable of interconnecting to the Internet or other IP-based network. Further, in the exemplary embodiment, system 200 includes one or more digital music devices 100 communicatively coupled to server system 212 and/or other digital music devices 100.

In the exemplary embodiment, a database server 216 operates on server system 212, and is connected to database 220, which contains information on a variety of matters, as described above. In one embodiment, database 220 can be accessed by digital music device 100 for purposes of user authentication as described herein. In an alternative embodiment, database 220 is stored remotely from server system 212 and may be non-centralized, such as from a plurality of users.

Database 220 may include a single database having separated sections or partitions, or may include multiple databases, each being separate from each other. Database 220 may store music sheet data and/or user annotation and edit data shared over network 215. Database 220 may also store user identification data associated with a user.

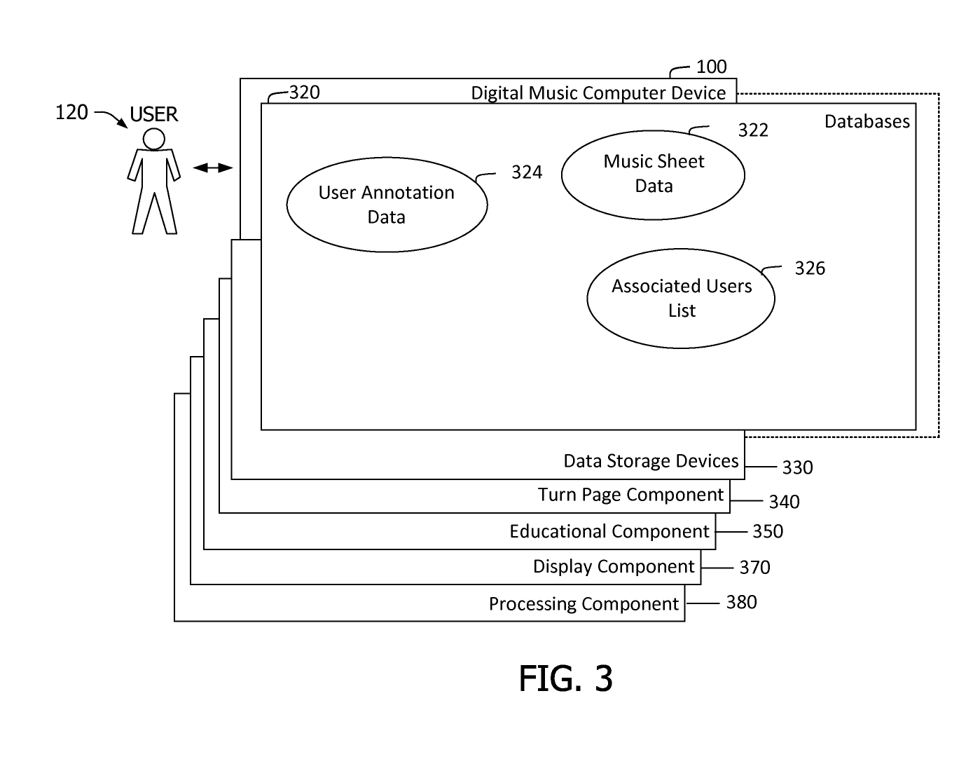

FIG. 3 shows an example configuration of a database within digital music device 100, along with other related computing components, that may be used to read, edit, annotate, and/or organize sheet music, and sets programs and playlists. Database 320 is coupled to several separate components within digital music device 100, which perform specific tasks.

In the exemplary embodiment, database 320 includes music sheet data 322, user annotation data 324, and an associated users list 326. In some embodiments, database 320 is similar to database 220 (shown in FIG. 2). Digital music device 100 includes database 320, as well as data storage devices 330. Digital music device 100 also includes a turn page component 340 for managing turning of the pages of the sheet music during a musical performance. Digital music device 100 also includes an educational component 350 for providing educational information to a user. A display component 370 is also included for interacting with a user 302, such as a conductor or musician. A processing component 380 assists with execution of computer-executable instructions associated with the digital music device.

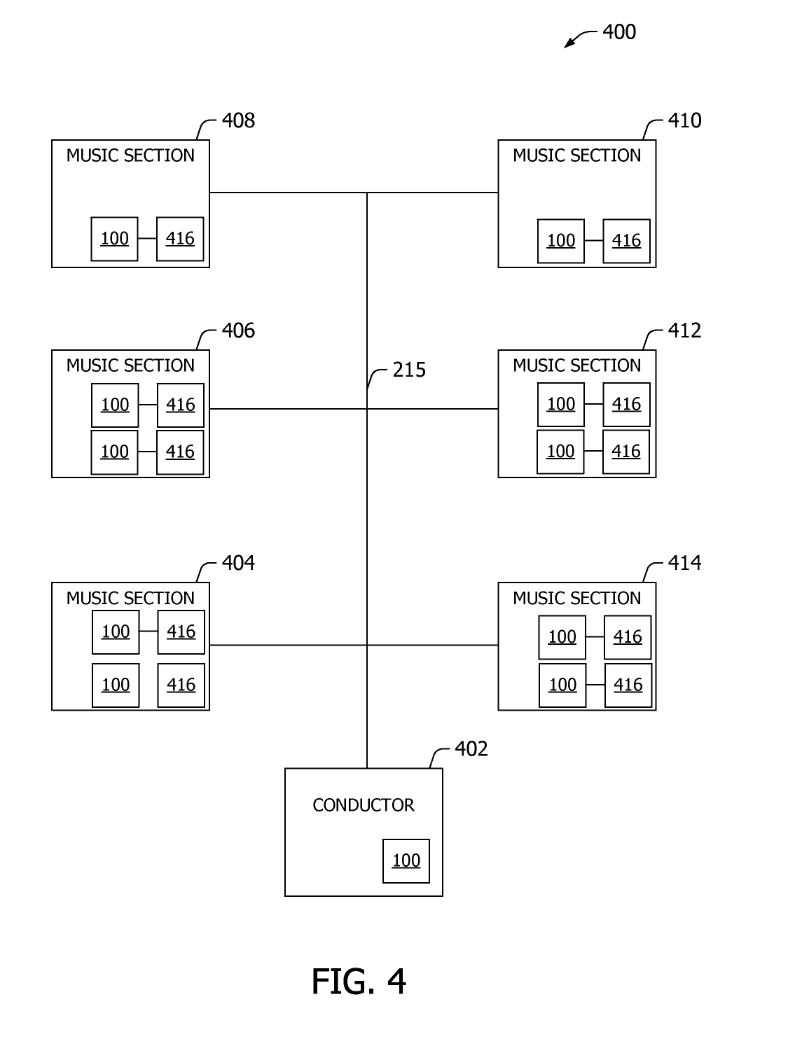

FIG. 4 is a block diagram of an example orchestral setting 400. In the exemplary embodiment, orchestral setting 400 includes a conductor 402 and a plurality of musical sections, 404, 406, 408, 410, 412, and 414. Each musical section 404-414 includes one or more musicians 416. Conductor 402 and musicians 416 each have a digital music device 100 (shown in FIG. 2). Conductor 402 is in communication with musicians 416 via digital music devices 100 over network 215, which may be based on one of a number of networking technologies such as the Internet or other wireless networking technology. Each musical section 404-414 may be associated with a different type of musical instrument. While six musical sections 404-414 are shown in FIG. 4, orchestral setting 400 is not limited to this number and may include any number of musical sections. Exemplary musical sections may include, but are not limited to including, first violin, second violin, viola, cello, bass, brass, woodwind and percussion. Within brass, woodwind, and percussion, more instruments may exist. For example, the brass section may further include, but is not limited to including, trumpet, trombone, tuba, French horn, sometimes saxophone. Sometimes pieces call for more obscure instruments, English horn for example. Woodwinds may include, but are not limited to including, flute, piccolo, bassoon, oboe, and clarinet. Percussion may include, but is not limited to including, tympani, bass drum, cymbals, xylophone, bells and many other instruments. Additionally, or alternatively, each musician 416 of each section may share or have individual unique parts.

In the exemplary embodiment, display component 370 is configured to display sheet music for a selected composition to user 120 via media output 115 (shown in FIG. 1). User 120 (i.e., conductor 402 and/or musicians 416) uses input device 125 (shown in FIG. 1) to select an existing composition stored in memory area 110 (shown in FIG. 1), or alternately creates a new composition. Digital music device 100 enables user 120 to make alterations, annotations, notes, and/or highlights to the sheet music. Each user 120 is registered with their own digital music device 100, so any alterations, annotations, notes, and/or highlights are stored locally in memory 110 and/or in the cloud. User 120 may share specified alterations, annotations, notes, and/or highlights to other digital music devices 100 associated with conductor 402, specified individual musicians 416, and/or all users in one or more musical sections 404-414.

In the exemplary embodiment, digital music device 100 is configured to display digital music data associated with a digital music composition. Digital music device 100 also receives additional data associated with the digital music data, the additional data input by a user. Receiving additional data may include receiving at least one of an annotation, an edit, a cut, a bowing, and a phrase associated with the digital music data. Receiving additional data may also include receiving at least one of an audible recording, a video recording, body movement information, an instant message, and decisions regarding musicality, performance and practice techniques and standards associated with the digital music data.

In the exemplary embodiment, digital music device 100 then combines the additional data and the digital music data to generate updated digital music data, and transmits the updated digital music data to at least one second digital music computer device in substantially real-time based on a transmit request input by the user. Transmitting the updated digital music data to at least one second digital music computer device in substantially real-time further includes transmitting the updated digital music data to a plurality of second digital music computer devices in substantially real-time. In one embodiment, transmitting the updated digital music data to a plurality of second digital music computer devices further includes selectively transmitting the updated digital music data to a subset of the plurality of second digital music computer devices. In another embodiment, digital music device 100 receives revised digital music data from the at least one second digital music computer device. The revised digital music data includes second additional data combined with the updated digital music data provided in response to the transmitting the updated digital music data.

In the exemplary embodiment, digital music device 100 supports digital music library management. User 120 may scan, save, and/or store documents/sheet music, lesson plans, and audio files. Additionally, user 120 may search, retrieve, share, play and print files. Digital music device 100 enables user 120 to organize the order of music for a rehearsal, a performance, and a set list, either collectively or individually. User 120 may search for or skip to a specific section or page. Digital music device 100 receives a search query input by user 120 and displays results that match the search query. Skipping to a specific page may result in a permanent cut to the score or it may be a temporary cut just for rehearsal, depending on a selection made by user 120 interacting with digital music device 100.

Digital music device 100 provides various features to user 120 for interacting with the sheet music. For example, user 120 may magnify a selected area of the sheet music and/or adjust a size of the scores on the sheet music by selecting an adjust score size option. Digital music device 100 receives the adjust score size command input by the user, and either increases or decreases a size of a score displayed on the digital music sheet based on the received adjust score size command.

Digital music device 100 is also configured to display a selectable bow marking button that enables user 120 to easily add bowings to the music. User 120 may share the bowings within one or more musical sections 404-414 or with individual musicians 416. Digital music device 100 further enables user 120 to edit and/or erase existing annotations on the sheet music.

In another embodiment, digital music device 100 displays a user-selectable tuner option. Upon selection of the tuner option by user 120, digital music device 100 provides a tuning function by displaying tuning notes for a user 120 to play using an instrument. Digital music device 100 receives test notes played using the instrument, wherein the test notes correlate to the tuning notes. Digital music device 100 compares the test notes to the tuning notes to determine whether the instrument is in-tune. Digital music device 100 then generates a visual response representing an accuracy of the pitch of the instrument based on the compared test notes and tuning notes. A count feature displays timing that counts rests and provides a countdown or notification to user 120 to resume performing. In some embodiments, the tuner function is built-in to digital music device 100.

In the exemplary embodiment, digital music device 100 includes Optical Character Recognition (OCR) technology that interacts with a measure count and page turn service to highlight measure count and rehearsal letters. The OCR technology also interacts with the measure count and page turn service to highlight Repeats, Volta Subito, Dal Capo, Codas, Del Segno, and cuts in the music. User 120 may also manage cuts of sections in the music, insert cut markings recognized by the OCR technology to skip and/or move forward sections.

In operation, during a rehearsal or a performance, a turn page component 340 of digital music device 100 turns the pages of the sheet music, as necessary. The page turns are elegantly automated to mimic appearance of a traditional page turn. In the exemplary embodiment, turn page component 340 monitors a turn page counter that indicates when a page of the digital music sheets should be turned, and turns the page upon occurrence of a turn page event. In one embodiment, turn page component 340 measures a countdown to turn page by synchronizing beats of the music to conductor's 402 baton or through a motion detection device worn by conductor 402. The motion detection device keeps count on measures and communicates with digital music device 100 to provide a turn page signal. In another embodiment, digital music device 100 measures a turn page countdown using an internal timer or metronome. In other embodiments, turn page component 340 is activated by one of a foot pedal coupled to digital music device 100, a hand motion, a touch, and/or a swipe on the screen of digital music device 100. In yet another embodiment, digital music device 100 tracks measure count and turns pages with use of a motion detection device, for example, Myo™ technology (Myo is a trademark of Thalmic Labs Incorporated located in Kitchener, Ontario, Canada). Digital music device 100 monitors the conductor, director, section leaders and/or selected individuals wearing the Myo technology to receive placement data representing a placement in the music. Digital music device 100 activates page turns at the appropriate times. In other embodiments, digital music device 100 utilizes a listening component to track placement in the music and activate page turns.

In the exemplary embodiment, one or more administrators (i.e., conductor 402, assistant conductor, librarian) are provided with administrative control over digital music devices 100 of musicians 416 in orchestral setting 400. An administrator is able to selectively provide real-time or delayed updates to user 120, a group of users 120, and/or one or more sections 404-414. For example, conductor 402 or the administrator can make annotations, edit, and/or make cuts to the sheet music during a rehearsal, as described above. After the music is marked-up, the administrator selects a distribute option for distributing the music to one or more other digital music devices 100. Within the distribute option, the administrator is prompted to specify desired recipients of the marked-up music. After the recipients are chosen, digital music device 100 transmits the marked-up music to specified sections 404-414 and/or musicians 416 in real time. The ability to edit and make cuts to music can occur in substantially real time and can automatically filter through sections or entire group. In some embodiments, the annotation, edit, and/or make cuts features are also available to each individual musician 416. In such embodiments, the administrator may also view, monitor, and/or adjust annotations made by any musician 416 on their respective digital music device 100. Annotations and highlights may be made with adjustable colors and font variations (i.e., thickness of pen marking, bold, italic). For example, conductor 402 may improve managing of a rehearsal by communicating to musicians 416 where to start by highlighting rehearsal letters and/or measures in the music on digital music device 100. Digital music device 100 transmits the highlighted rehearsal letters and/or measures to digital music device 100 associated with each musician 416 in substantially real-time. Upon receipt, digital music devices 100 display the mark-ups to musicians 416.

Other administrative options available to the administrator include, but are not limited to, making bow markings to the sheet music, phrasing the sheet music, making a road map of the sheet music, and highlighting musical markings such as Repeats, Volta Subito, Del Capo, Codas, Del Segno, phrase and breath markings, Vamps, 2nd repeat, 3×, 4×, multiple and varied repeat options, alternate endings, crescendo, decrescendo, and/or dynamics in the sheet music. In the exemplary embodiment, automatic notations about bow markings, articulation, phrasing, movements, gestures, style, and technique are captured and shared by Myo technology and/or pressure sensors that provide an optional graphical representation of claimed techniques. Making a road map enables user 120 to take or cut repeats, cuts in lines of music, dal capo, coda; and del segno. In other embodiments, depending on the authorization provided by the administrator, conductor 402 may have administrative control over digital music devices 100 for all musicians 416, a designated leader of each musical section 404-414 may control digital music devices 100 for each musician 416 in their respective section, or individual musicians 416 may have control only over their respective digital music device 100. The administrative rights described herein may be assigned to any one or more of conductor 402, a section leader, and/or individual musicians 416.

In the exemplary embodiment, digital music device 100 includes an instant messaging function that enables messages to be transmitted between digital music devices 100. For example, a musician 416 sitting in section 404 may transmit a message to another musician 416 sitting in section 410. The administrator has administrative control over the instant messaging function and which users 120 have access to the instant messaging function. For example, the administrator may turn off the instant messaging function for one or more specified digital music devices 100 and/or may control which users 120 have the ability to send messages.

In the exemplary embodiment, digital music device 100 includes an educational component 350 configured to provide educational and practice information to user 120. For example, in one embodiment, educational component 350 includes an information function that provides additional information about the music to user 120. User 120 launches the information function and selects sections of the music. Educational component 350 receives the selected sections of the music and retrieves the additional information about the music. Additional information may include the edition, artistic options and choices, and demonstrations related to the music. The additional information may either be stored in memory 110 or database 220, or educational component 350 may access the Internet and provide a link to the information. When displaying the additional information, educational component 350 may incorporate video demonstrations and/or access to subscribed performance editions or videos.

In another embodiment, educational component 350 includes a play along measure count function that communicates a play along measure count of the composition to user 120. User 120 may adjust the play along measure count to user's 120 particular skill level to increase the quality of the practice session. For example, educational component 350 provides a measure-to-measure highlight for a beginner skill level. Educational component 350 highlights a section letter upon approach during the composition. Educational component 350 may further include a built-in metronome to assist in communicating measure counts.

In another embodiment, educational component 350 includes a record and playback function that records a performance and enables playback to user 120. The record and playback function enables user 120 to review the performance to see if any errors were made so they may be improved on. The record and playback function includes a distribute recordings option that enables user 120 to selectively share audio recordings with other digital music devices 100. Sharing of the audio recordings between multiple users 120 increases the knowledge of the entire group, which in turn, improves the quality subsequent performances.

In another embodiment, educational component 350 includes a play along audio recording function that enables user 120 to upload audio files to digital music device 100 that they can play along with for practice. Educational component 350 records the performances and enables user 120 to listen to the audio recording. Additionally, educational component 350 also enables play along with audio recordings of a displayed accompaniment or full score, either in full or in excerpt. Educational component 350 digitally analyzes the sound profile generated by user 120 and provides user 120 with focused reduction or amplification of parts to practice along with.

In another embodiment, educational component 350 further includes a viewing function that enables user 120 to view a full score, to view specific parts, and/or to view user parts. Any one of a full score, specific parts, and/or user parts of the music may be viewed with a real time curser that tracks the music alongside an audio recording and/or the musicians while playing the music.

In another embodiment, educational component 350 includes a performance alert function that provides tempo and/or pitch alerts while user 120 plays along with the sheet music. Educational component 350 tracks the music input by user 120 and determines the tempo and pitch played by user 120. Educational component 350 compares the user tempo and pitch to a proper tempo and pitch stored in memory 110 and transmits an alert when the tempo/rhythm and/or pitch/intonation of user 120 is incorrect. The alert may be a visual and/or audible alert.

In another embodiment, educational component 350 includes an audible playback function that records the music input by user 120 and provides audible playback. Educational component 350 stores the music played by user 120 in memory 110 as sheet music and compares it to standard sheet music. Educational component 350 marks-up any errors made by user 120 and generates a report of problem areas for user 120 to improve on. The report may be either a marked-up version of the sheet music or a print-out report. Depending on the authorization provided by the administrator, the report may be transmitted to a digital music device 100 associated with one or more of user 120, a teacher, a section leader, a conductor, and a director.

In another embodiment, educational component 350 includes a lesson building function that enables a teacher or director to build individual and/or group lessons within sheet music and share the lessons with digital music devices 100. More specifically, educational component 350 enables a teacher or director to indicate or compose phrases and/or sections on the sheet music for practice. The teacher or director may also mark phrases or notes, add fingerings, and/or create practice techniques. The teacher or director may selectively assign the lessons to particular users 120 and educational component 350 transmits the lessons to the proper digital music devices 100. As assigned users 120 practice on their digital music devices 100, educational component 350 associated with respective digital music devices 100 may generate audible recordings, generate visual recordings including tracked cues on the sheet music, and/or capture other performance data. Depending on the authorization provided by the administrator, the recorded data may be transmitted to digital music device 100 associated with one or more of user 120, a teacher, a section leader, a conductor, and a director.

In another embodiment, educational component 350 includes a live video interaction feed that enables teachers and students or ensembles to communicate visually and audibly with one another from different physical locations. The live video interaction feed enables lessons and rehearsals to occur when at least one user 120 is located remotely from other users 120.

In some embodiments, digital music device 100 includes a copyright protection function. The copyright protection function assists in preventing copyright violations of sheet music. For example, the copyright protection function monitors printing and usage of the sheet music. The copyright protection function can be used to set thresholds for a number of prints available and a time limit for access to the music before expiration. Moreover, the copyright protection function may watermark sheets printed from digital music device 100 to protect publishing rights.

In the exemplary embodiment, digital music device 100 is configured to be click-track capable. Moreover, digital music device 100 includes one or more headphone ports.

In one embodiment, digital music device 100 supports integration of complimentary software applications such as, client-based and web-based solutions. For example, digital music device 100 may operate with websites that supply music digitally and provide the ability to break up a score into individual parts or any other type of complimentary software applications.

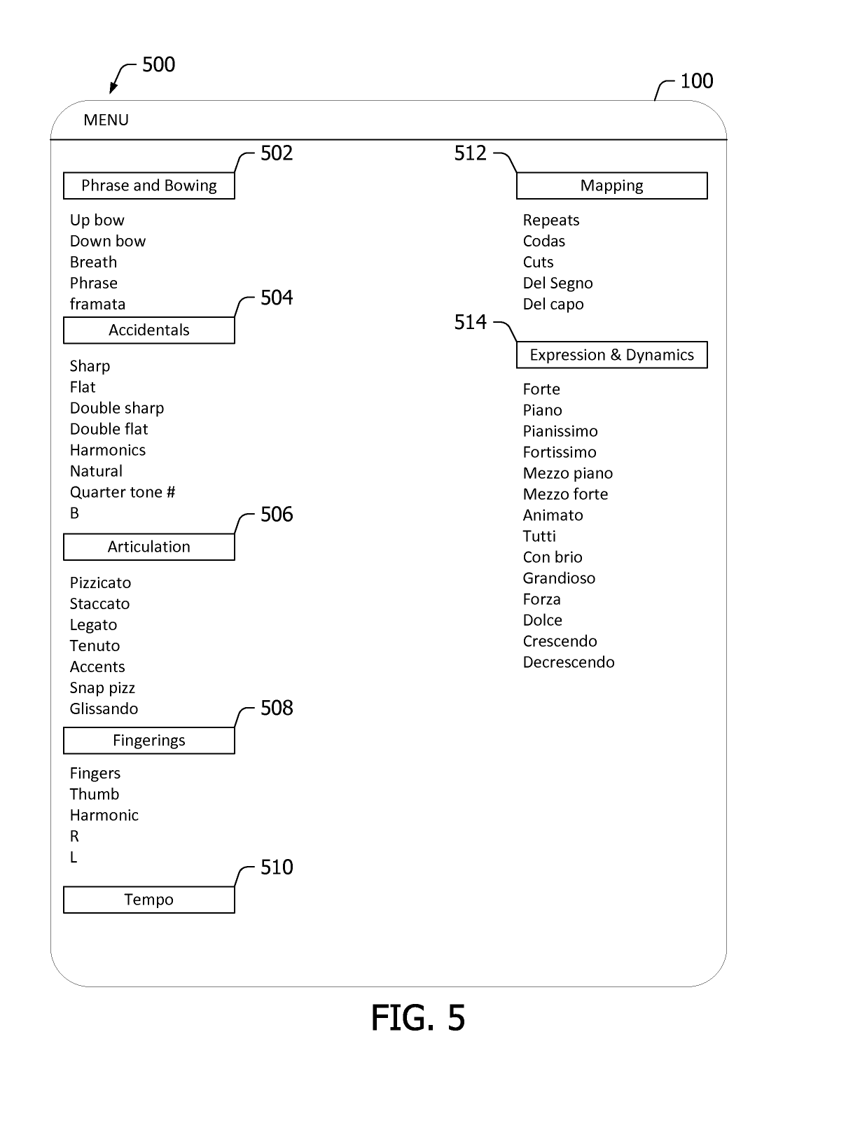

FIG. 5 is a screenshot of an exemplary menu 500 of digital music device 100. In the exemplary embodiment, upon selection by user 120, menu 500 displays a plurality of options that enable user 120 to interact with the sheet music. The menu options are provided in a drop-down menu that remains minimized until selected by user. In the exemplary embodiment, menu 500 includes a plurality of options sorted within sections. The sections include, but are not limited to including, a Phrase and Bowing section 502, an Accidentals section 504, an Articulation section 506, a Fingerings section 508, a Tempo section 510, a Mapping section 512, and an Expression and Dynamics section 514. Phrase and Bowing section 502 includes a plurality of options including, but not limited to, up bow, down bow, breath, phrase, and fermata. Accidentals section 504 includes a plurality of options including, but not limited to, sharp, flat, double sharp, double flat, harmonics, natural, and quarter tone # and b. Articulation section 506 includes a plurality of options including, but not limited to, pizzicato, staccato, legato, tenuto, accents, snap pizz, and glissando. Fingerings section 508 includes a plurality of options including, but not limited to, fingers, thumb, harmonic, “R”, and “L”. Mapping section 512 includes a plurality of options including, but not limited to, repeats, codas, cuts, Del Segno, and Del capo. Expression and Dynamics section 514 includes a plurality of options including, but not limited to, forte, piano, pianissimo, fortissimo, mezzo piano, mezzo forte, animato, tutti, con brio, grandioso, forza, dolce, crescendo, and decrescendo.

In one embodiment, menu 500 includes a shortcut code associated with each term. User 120 would then be able to input the shortcut code that would then drop the correct item in place.

In another embodiment, digital music device 100 includes a query function and/or a built in musical dictionary. For example, if user 120 has a question about a marking, a term, a passage, etc. in the music, user 120 could perform a search. Digital music device 100 would provide a list of search results based on the search query. For example, if the term “Snap Pizzacato” is searched and digital music device 100 finds the definition from the dictionary as well as a video and audio sample from educational component 350, it will display each result in a list. In other embodiments, digital music device 100 utilizes OCR to assist with the search process, so user 120 can touch the item in question on the music and perform the search.

To use the shortcut code and/or the query function described above, digital music device 100 includes a popup keyboard that is displayed when user 120 selects either function. The keyboard may include font variations in type, size, and/or color.

The digital music computer device and methods described herein enable managing of digital music. The various methods of interaction (for example: automatic sharing of information, annotations, phrases, instant messaging, and video interaction) between individuals and groups facilitated by the digital music device and methods described herein improves musical performance and education for all participants. Conductors, directors, leaders, teachers may communicate live and offline with pushed updates regarding decisions about musicality, performance, and practice techniques and standards. Moreover, conductors, directors, leaders, and teachers may observe performances and practices through notations provided by users, video and audio recordings, and observation of body movement using Myo technology.

Moreover, as opposed to prior methods of managing digital music that included musicians in an ensemble reading and practicing music with autonomy, the digital music computer device and methods described herein enable musicians practicing in an ensemble to operate cohesively as a group. When playing in an ensemble, the group is led by a conductor, director and section leaders. As decisions are made during rehearsal and practice (such as bowing and phrasing decisions) by the different layers of authority, the digital music computer device enables updated information to be shared to the entire ensemble, a particular section, a group, and/or selected musicians in real-time in a live environment, which enhances overall musical performance and education of musicians.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.) or equivalent technology. In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The systems and processes are not limited to the specific embodiments described herein. In addition, components of each system and each process can be practiced independent and separate from other components and processes described herein. Each component and process also can be used in combination with other assembly packages and processes.

As used herein, an element or step recited in the singular and proceeded with the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. In other words, the machine-readable medium and the computer-readable medium described herein are non-transitory. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A digital music computer device for managing digital music, said digital music computer device comprising:
a memory; and
a processor communicatively coupled to the memory, said processor programmed to:
display digital music data associated with a digital music composition;
receive additional data associated with the digital music data, the additional data input by a user;
combine the additional data and the digital music data to generate updated digital music data; and
transmit the updated digital music data to at least one second digital music computer device in substantially real-time based on a transmit request input by the user.

2. The digital music computer device according to claim 1, wherein to receive additional data associated with the digital music data, said processor is further programmed to receive at least one of an annotation, an edit, a cut, a bowing, and a phrase associated with the digital music data.

3. The digital music computer device according to claim 1, wherein to receive additional data associated with the digital music data, said processor is further programmed to receive at least one of an audible recording, a video recording, body movement information, an instant message, and decisions regarding musicality, performance and practice techniques and standards associated with the digital music data.

4. The digital music computer device according to claim 1, wherein to transmit the updated digital music data to at least one second digital music computer device in substantially real-time, said processor is further programmed to transmit the updated digital music data to a plurality of second digital music computer devices in substantially real-time.

5. The digital music computer device according to claim 4, wherein to transmit the updated digital music data to the plurality of second digital music computer devices in substantially real-time, said processor is further programmed to selectively transmit the updated digital music data to a subset of the plurality of second digital music computer devices.

6. The digital music computer device according to claim 1, wherein said processor is further programmed to receive revised digital music data from the at least one second digital music computer device, the revised digital music data including second additional data combined with the updated digital music data provided in response to the transmitting the updated digital music data.

7. The digital music computer device according to claim 1, wherein said processor is further programmed to:
communicate a play along measure count of the digital music composition to the user based on a skill level of the user; and
highlight a section letter upon approach during the digital music composition.

8. The digital music computer device according to claim 1, wherein said processor is further programmed to:
generate an audio recording of a performance of the digital music composition by the user;
enable playback of the audio recording for user review; and
selectively transmit the audio recording to the at least one second digital music computer device.

9. The digital music computer device according to claim 1, wherein said processor is further programmed to:
display a full score of the digital music composition;
generate an audio recording of a sound profile of the user playing along with an audio recording of the digital music composition;
digitally analyze the sound profile; and
display one of a focused reduction and an amplification of parts for the user to practice along with.

10. The digital music computer device according to claim 1, wherein said processor is further programmed to:
track an input from the user using an instrument;
decipher at least one of a tempo and a pitch played by the user;
compare the at least one of the tempo and the pitch played by user to a proper tempo and pitch stored in the memory; and
transmit an alert when the at least one of the tempo and the pitch of the user is incorrect.

11. A computer-implemented method for managing digital music using a digital music computer device having a processor and a memory, said method comprising:
displaying, by the digital music computer device, digital music data associated with a digital music composition;
receiving, by the digital music computer device, additional data associated with the digital music data, the additional data input by a user;
combining, by the digital music computer device, the additional data and the digital music data to generate updated digital music data; and
transmitting, by the digital music computer device, the updated digital music data to at least one second digital music computer device in substantially real-time based on a transmit request input by the user.

12. The method according to claim 11, wherein receiving additional data associated with the digital music data further comprises receiving at least one of an annotation, an edit, a cut, a bowing, and a phrase associated with the digital music data.

13. The method according to claim 11, wherein receiving additional data associated with the digital music data further comprises receiving at least one of an audible recording, a video recording, body movement information, an instant message, and decisions regarding musicality, performance and practice techniques and standards associated with the digital music data.

14. The method according to claim 11, wherein transmitting the updated digital music data to at least one second digital music computer device in substantially real-time further comprises transmitting the updated digital music data to a plurality of second digital music computer devices in substantially real-time.

15. The method according to claim 14, wherein transmitting the updated digital music data to a plurality of second digital music computer devices in substantially real-time further comprises selectively transmitting the updated digital music data to a subset of the plurality of second digital music computer devices.

16. The method according to claim 11, further comprising receiving revised digital music data from the at least one second digital music computer device, the revised digital music data including second additional data combined with the updated digital music data provided in response to the transmitting the updated digital music data.

17. The method according to claim 11, further comprising:
communicating a play along measure count of the digital music composition to the user based on a skill level of the user; and
highlighting a section letter upon approach during the digital music composition.

18. The method according to claim 11, further comprising:
generating an audio recording of a performance of the digital music composition by the user;
enabling playback of the audio recording for user review; and
selectively transmitting the audio recording to the at least one second digital music computer device.

19. The method according to claim 11, further comprising:
displaying a full score of the digital music composition;
generating an audio recording of a sound profile of the user playing along with an audio recording of the digital music composition;
digitally analyzing the sound profile; and
displaying one of a focused reduction and an amplification of parts for the user to practice along with.

20. The method according to claim 11, further comprising:
tracking an input from the user using an instrument;
deciphering at least one of a tempo and a pitch played by the user;
comparing the at least one of the tempo and the pitch played by user to a proper tempo and pitch stored in the memory; and
transmitting an alert when the at least one of the tempo and the pitch of the user is incorrect.
